(19) United States
(12) Patent Application Publication
(10) Pub. No.: US 2010/0300494 A1
(43) Pub. Date: Dec. 2, 2010

(54) FILTER CARTRIDGE, AND DEVICE AND METHOD FOR CLEANING A FILTER CARTRIDGE

(76) Inventors: Christophe Corailler, Paris (FR); Le Foll Pierre, La Foret Fouesnant (FR)

Correspondence Address: SCHLUMBERGER OILFIELD SERVICES, 200 GILLINGHAM LANE, MD 200-9, SUGAR LAND, TX, 77478, US

(21) Appl. No.: 12/744,338

(22) PCT Filed: Nov. 21, 2008
(86) PCT No.: PCT/EP08/09906

§ 371 Date: Aug. 16, 2010

Related U.S. Application Data
(60) Provisional application No. 60/989,854, filed on Nov. 23, 2007.

(51) Int. Cl. B01D 41/04; B01D 35/30

(52) U.S. Cl. 134/33; 210/232; 134/157; 134/152; 134/104.2

(57) ABSTRACT

A reusable filter cartridge having a symmetrical structure, the reusable filter cartridge comprising a tubular outer pipe having perforations arranged therein. A tubular inner pipe having perforations is arranged therein, and has a smaller diameter than the diameter of the outer pipe such that an annulus is formed between the outer and inner pipes. A filtering media is disposed in the annulus between the outer and inner pipes. A first and second lid is provided, each being secured at opposite ends of the outer and inner pipes; one of the lids having a central opening therein for water to flow out of or into the inner pipe. The reusable filter cartridge further comprises a coupling arrangement for coupling the filter cartridge with a rotating element of a cleaning device so that the filter media can be cleaned by rotation of the filter cartridge around its axis inside the cleaning device. The invention further includes a cleaning device for cleaning a reusable filter cartridge and a method for cleaning a used filter cartridge.

### CROSS-REFERENCE TO RELATED APPLICATIONS

The present application is based on and claims priority to U.S. Provisional Application No. 60/989,854, filed 23 Nov. 2007; and International Patent Application No. PCT/EP2008/009906, filed 21 Nov. 2008. The entire contents of each are herein incorporated by reference.

### FIELD OF THE INVENTION

The invention relates to a reusable filter cartridge, and to a cleaning device and a method for cleaning the filter material used in the cartridge without removing the filter material from the cartridge. In particular, the invention relates to a reusable radial flow water filter cartridge which may be used in light water treatment units for treating used water from oil and gas wells.

### BACKGROUND OF THE INVENTION

In oil drilling processes, water is injected in a well for a variety of reasons which are well known to persons skilled in this art. For instance water may be injected into a reservoir to increase pressure and thereby stimulate production. The water may be produced water or a combination of produced water and make up water such as ocean water depending on the needs of the reservoir. The used water typically contains residues made up of oil and other water contaminants which must be substantially removed from the water before the water can be disposed to the environment safely. In a typical water treatment process, the used water is flowed through a container or cartridge that contains suitable filtering material. Many different types of filtering material are presently used. These types of filtering material are effective in retaining oil, solids and other contaminants found in the used water while allowing clean water to pass through. The specific geometry of the cartridges may also vary.

When the filtering material becomes saturated with the water contaminants the cartridges with the filtering material are typically disposed of as spent cartridges and are replaced with new ones. Alternatively, some water treatment processes utilize cartridges that can be opened to remove the filtering material to clean it and then reinsert it inside the cartridge for further use. Cleaning of the filtering material may be performed by a variety of methods depending upon the type of the filtering material used. Existing processes are generally limited in that they are labor intensive and rather costly. Also, typically the removal, cleaning and re-insertion of the filtering media inside the cartridges is a rather difficult and labor intensive process. For instance, one problem experienced in the field is that the filtering media often needs to be carefully compacted to fit within the cartridge a process which is labor intensive and time consuming.

One of the advantages of the present invention is that it relates to a reusable filter cartridge which is designed to be readily mountable on a rotating element for cleaning the filtering material after its use by removing substantially all residues accumulated in the filtering media at least partially through centrifugal forces. In this way the filtering material does not have to be removed from the cartridge in order to be recycled and reused, thus saving time, being more cost effective and being less labor intensive.

### SUMMARY OF THE INVENTION

According to one aspect of the invention there is provided a reusable filter cartridge comprising:
a tubular outer pipe having perforations arranged therein;
a tubular inner pipe having perforations arranged therein, and having a smaller diameter than the diameter of the outer pipe such that an annulus is formed between the outer and inner pipes;
a filtering media disposed in the annulus between the outer and inner pipes;
a first and a second lid, each being secured at opposite ends of the outer and inner pipes, one of the lids having a central opening therein for water to flow out of or into the inner pipe; and
wherein the reusable filter cartridge further comprises a coupling arrangement for coupling the filter cartridge with a rotating element of a cleaning device so that the filter media can be cleaned by rotation of the filter cartridge around its axis inside the cleaning device.

The coupling arrangement may be an extending sleeve member securely attached to or integrally formed with one of the lids having a central opening therein and which can couple with a rotating element of the cleaning device so that the filtering cartridge can rotate about its axis.

The filter cartridge according to the invention is preferably a radial flow water filter cartridge.

Preferably, the filtering media is a polymer material, and in particular the filtering media is preferably a polyurethane based material.

Preferably, the reusable filter cartridge has a symmetrical structure.

According to second aspect of the present invention there is provided a cleaning device for cleaning a used reusable filter cartridge as described above, which includes residues, the cleaning device comprising:
a housing, and
wherein at least one coupling arrangement to which the reusable filter cartridge is attachable is located in the housing; and
an actuating means being operably attached to the coupling arrangement for rotating the coupling arrangement in order to substantially remove most of the residues at least partially through centrifugation.

In one form of the invention the cleaning device further includes a cleaning fluid injection system which enables a cleaning fluid to be injectable into the reusable filter cartridge when it is connected to the rotating bearing.

The actuating means may comprise a variable speed controller to vary the speed at which the reusable filter cartridge is rotated.

In one form of the invention the housing may further comprise a protection shield mounted to surround the reusable filter cartridge and it may receive residues which are able to exit the filter cartridge due to centrifugal forces during the cleaning process.

The cleaning device may further comprise a recovery vessel which is mounted relative to the protection shield to receive the residues from the protection shield.

In one form of the invention the residues include oil.

Preferably, most of the residues are removed from the filter cartridge because of the centrifugal forces caused by the rotation of the coupling arrangement but the cleaning process may also be aided by injecting a liquid such as water.

According to a preferred embodiment the used filter cartridge is placed within the cleaning device via the coupling arrangement and liquid such as water is added inside the cleaning device. The filter cartridge is then rotated at a sufficient speed to allow the residues to be removed from the filtering media via a combination of the centrifugal forces and the forces from the water. Preferably, a constant flow of water may be maintained by injecting water inside the cleaning device and removing it (or re-circulating through a water circuit) to carry out and/or facilitate the removal of the dislodged residue.

The coupling arrangement may be, for example, a rotating bearing operably mounted in the housing. The actuating means may be operably attached to the rotating bearing to cause the bearing and the coupled filter cartridge to rotate at an effective speed to allow for substantially most of the residue oil and other contaminants to be removed, preferably also with the aid of an injected liquid.

According to a third aspect of the invention there is provided a method for cleaning a reusable filter cartridge as described above using a cleaning device as described above, the method comprising:
coupling the reusable filter cartridge to the cleaning device; and
rotating the reusable filter cartridge at a sufficiently high speed to substantially remove the residues captured inside the filter cartridge through the centrifugal effect caused by the rotation.

Further according to the invention the method may further comprise injecting a liquid such as a cleaning fluid into the reusable filter cartridge to assist the cleaning process.

Preferably, the speed of rotation of the reusable filter cartridge can be varied.

### BRIEF DESCRIPTION OF THE DRAWINGS

The invention will now be described using examples of preferred embodiments and referring to Figures, wherein:

FIG. 1 shows a schematic view of a reusable filter cartridge according to one embodiment of the invention;

FIGS. 2 and 3 show schematic side views of a transversal cut through A-A of the reusable filter cartridge of FIG. 1; and

FIG. 4 shows a schematic side view of a cleaning device according to an embodiment of the invention.

### DETAILED DESCRIPTION OF THE INVENTION

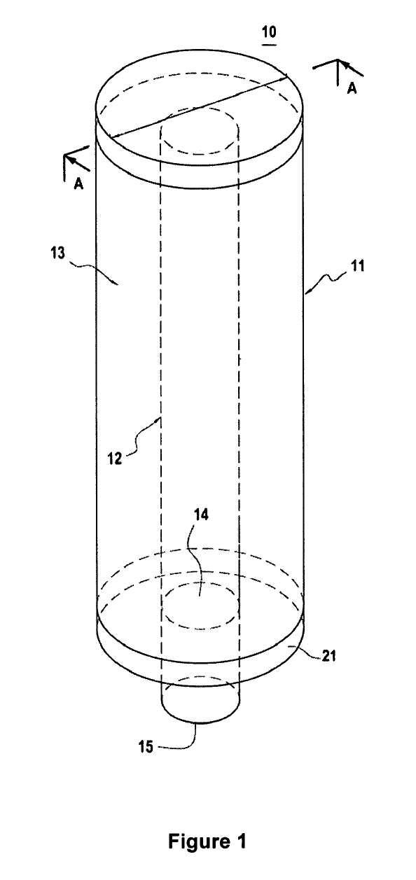

FIGS. 1 to 3 represent a preferred embodiment of a reusable filter cartridge according to the invention.

According to FIG. 1, a reusable filter cartridge 10 is shown having a symmetrical structure and comprising an outer pipe 11, having perforations (not shown in FIG. 1) and an inner pipe 12 (shown in dotted lines), having perforations (also not shown in FIG. 1). Inner pipe 12 has a smaller diameter than that of the outer pipe 11. Inner pipe 12 is positioned inside outer pipe 11, thereby defining an annulus space between inner pipe 12 and outer pipe 11. A filtering media 13 is located in this annulus space. The cartridge 10 further comprises first and second lids (not shown in FIG. 1), each lid being secured at opposite ends of the cartridge, one of the lids having a central opening therein which is connected to an opening 14 of the inner pipe 12, for the water to flow out of or into the inner pipe 12. The cartridge 10 also comprises an extending sleeve member 15 adapted to be used with one of the lids, and adapted to extend through one of the lids and to cooperate with a rotating bearing of a cleaning device, so that the filter cartridge can spin about its own axis.

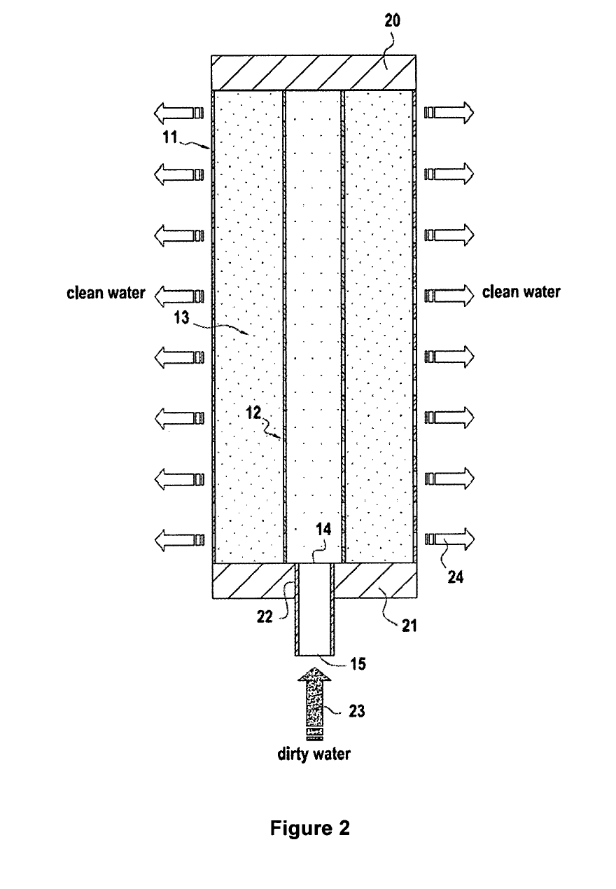

FIG. 2 shows a schematic side view of a transverse cut in the filter cartridge of FIG. 1 along the line A-A. FIG. 2 shows the outer pipe 11, the inner pipe 12 and the annulus or media space filled with the filtering media 13. The perforations in the inner pipe 12 and in the outer pipe 11 are represented by means of dotted lines. The filter cartridge is terminated at its extremities by lids 20 and 21, and the lid 21 has an opening 22 therein. Arrows 23 and 24 show a first possible flow of water through the filter cartridge during the filtering process. According to the first possible flow, dirty water to be filtered, represented by the arrow 23, enters through the opening 22 into the filter cartridge and radially flows out of the filter cartridge, firstly through the perforations in the inner pipe 12 and then through the perforations in the outer pipe 11, as represented by the arrows 24. The first possible flow may also be called outward flow configuration.

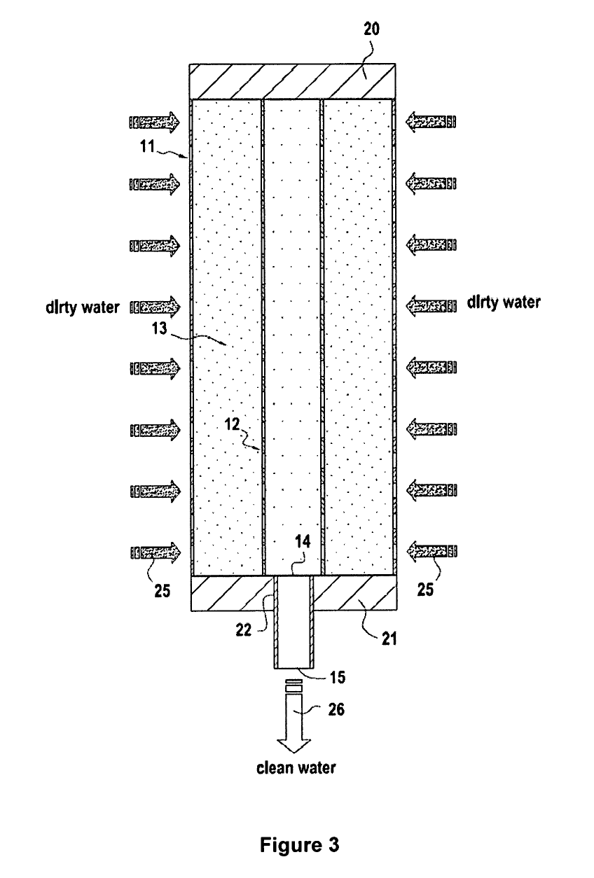

FIG. 3 represents a further view of the same transversal cut as shown in FIG. 2, wherein the flow of water is inverted as compared to FIG. 2 and corresponds to an inward flow configuration. In this configuration, dirty water to be filtered represented by arrows 25 enters the filter cartridge through the perforation in the outer pipe 11, flows through the filtering media 13 and the perforations in the inner pipe 12, before leaving the filter cartridge as cleaner water through the opening 22. The outgoing cleaner water is represented by an arrow 26.

The filter cartridge according to the invention has the advantage over prior art cartridges in that the filtering media does not need to be removed from the cartridge in order to be recycled. The specific features of the filter cartridge allows for any material retained inside the filtering media to be extracted without opening the cartridge. The filter cartridge may be a water filter and the substances retained in the filtering media as residues may, for example, be solids and/or oil.

Any type of reusable filter media can be used as the filtering media in the annulus of the filter cartridge of the invention provided that it has sufficient strength to withstand the centrifugal forces needed to remove the residues during the cleaning process. Preferred reusable filtering media that may be used in the reusable filter cartridge according to the invention, includes polyurethane based material with strong oleophilic properties, such as, for example, RPA material commercially available from TORR Canada Inc.

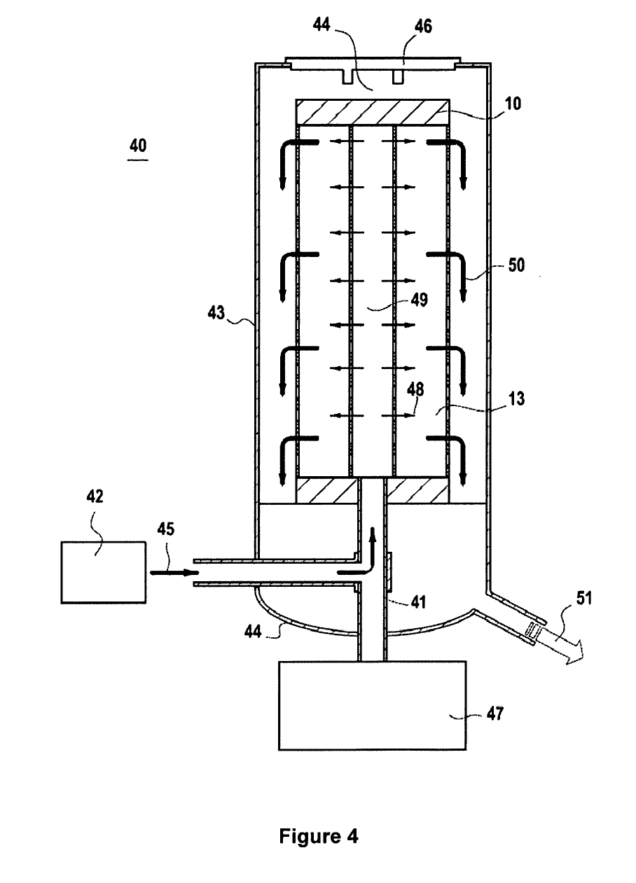

FIG. 4 shows a cleaning device 40 for cleaning a filter cartridge 10 according to the invention. The cleaning device 40 comprises a housing (43, 44) and at least one rotating bearing 41 mounted in the housing, on which the filter cartridge 10 can be mounted vertically so that it can spin about its own axis. It further comprises a cartridge insertion door 46, which may be opened to insert the filter cartridge 10 in the cleaning device 40, and, when closed, cooperates with the rotating bearing 41 to hold the cartridge in place inside the cleaning device 40. Actuating means 47 is mounted, attached to the rotating bearing 41, to rotate filter cartridge 10 inside cleaning device 40 in order to remove the residues captured inside the filter cartridge through the centrifugal effect of the rotational motion of the filter cartridge. The actuating means comprises, for example, an electrical motor operatively coupled with the rotating bearing 41. Preferably, the motor is a variable speed electric motor which is able to adapt the rotational speed during the cleaning process. An optional cleaning fluid injection system 42 allows injecting cleaning fluid inside the filter cartridge 10 when the cartridge is rotated. The flow of injected cleaning fluid is represented by the arrow 45, and arrows 48, where the cleaning fluid passes from the rotational bearing 41 into the perforations of the cartridge's inner pipe. Accordingly, in a preferred embodiment, the rotational bearing 41 may comprise a perforated tube 49 having perforations in it's wall, wherein the perforated tube 49 is operatively connected to the cleaning fluid injection system 42 such that the cleaning fluid is injected inside the perforated tube 49 and exits the perforated tube 49 through the perforations before arriving inside the filter cartridge 10.

In the preferred embodiment of the cleaning device as shown in FIG. 4, the housing comprises a protection shield 43 mounted to surround the filter cartridge 10 when the cartridge is positioned in the cleaning device 40. When the cartridge 10 is rotated, the protection shield 43 receives residue substances exiting the cartridge 10 through the effect of centrifugal forces. The exiting residue substances are represented as arrows 50. The substances may comprise injected cleaning fluid, and, for example, solids and oil previously retained in the cleaning media 13. The housing further comprises a recovery vessel 44, mounted relative to the protection shield 43 to receive the substances when the substances are subject to gravitational forces. An optional drain 51 may be connected to the recovery vessel 44 to allow the removal of substances.

The cleaning device 40 allows the filter cartridge 10 to be spun at a sufficient speed to permit removal of substantially all of the residue contaminants through centrifugation and also preferably with the aid of an injected liquid. In one embodiment the removal of substantially all of the residue contaminants can be accomplished by centrifugal forces alone and not without the use of any aid from any injected liquid. The very large centrifugal forces obtained at high rotating speeds in combination with the design of the filter media allows the residues foreign substances, including possible solids and/or oil, to be squeezed out of the filtering media 13 by centrifugal forces. Preferably, the cartridge 10 should be rotated at a speed of from about 500 rpm to about 5,000 rpm, more preferably from about 1000 to about 3000 rpm.

The optional cleaning fluid injection system may allow the further improvement in the efficiency of the cleaning process. Automatic flow rate control of the cleaning fluid may also be included to optimize the injected quantity of cleaning fluid and achieve an even better cleaning of the cartridge.

The cartridge 10 needs to be rotated at a sufficiently fast speed of rotation to achieve effective clean up. Typically a sufficiently fast speed would be several thousands rotations per minute (rpm) as mentioned above. Therefore, the filtering media holding structure, i.e., the inner pipe and the outer pipe and any further structure elements, must be strong enough to withhold the forces that are developed during the cleaning process. The coupling arrangement should be such as to allow the filter cartridge to be readily attached and detached from the cleaning device and kept well positioned in place during rotation. Easy balancing and centering will avoid any unwanted movement and vibrations which may lead to the damage of the filter cartridge.

The filter cartridge 10 should have an overall shape that is symmetric relative to its rotational axis when inserted into the cleaning device. In a preferred embodiment, the filter cartridge 10 has a cylindrical, elongated shape, i.e., the outer pipe 11 is a cylinder, the inner pipe 12 is a cylinder, and the inner pipe 12 is located concentrically inside the outer pipe 11. In this preferred embodiment, the longitudinal symmetry axis of the outer pipe 11 and the longitudinal symmetry axis of the inner pipe 12 are the same as the rotational axis of the filter cartridge inside the cleaning device 40.

This elongated cylindrical geometry is preferred because it offers advantages both during use of the cartridge for filtering used dirty water and during its recycling according to the present invention method and system.

After a determined period of rotation inside the cleaning device, the filter cartridge may be considered to be clean and ready to be reused. According to one embodiment the reusable filter cartridge (10) comprises;
a tubular outer pipe (11) having perforations arranged therein;
a tubular inner pipe (12) having perforations arranged therein, the inner pipe having a smaller diameter than the diameter of the outer pipe;
a filtering media (13) disposed between the outer and inner pipes;
a first and a second lid (20, 21), each being secured at opposite ends of the cartridge, one of the lids having a central opening (14) therein for the water to flow out of or into the inner pipe; and
an extending sleeve member (15) adapted to one of the lids, and adapted to cooperate with a rotating bearing of a cleaning device, so that the filter cartridge can rotate about its axis.

The reusable filter cartridge is preferably a reusable water filter cartridge, and may preferably have a radial flow path for the water being filtered therethrough.

The filtering media is preferably a polymer and may more preferably be made of polyurethane based material.

Preferably, the reusable filter cartridge has a symmetrical structure.

Another embodiment of the present invention relates to a cleaning device for cleaning a used filter cartridge, the cleaning device comprising
a housing (43, 44),
at least one rotating bearing (41) mounted in the housing and adapted to receive a filter cartridge to be cleaned, and
actuating means (47) attached to the rotating bearing for rotating the rotating bearing and the filter cartridge in order to remove the residues captured inside the filter cartridge through the centrifugal effect caused by the rotation.

The cleaning device may further comprise
a protection shield (43),
a recovery vessel (44), wherein the protection shield is mounted to surround the at least one filter cartridge and to receive the residues exiting the filter cartridge through the effect of centrifugal forces and wherein the recovery vessel is mounted relative to the protection shield to receive the residues.

The cleaning device further may comprise a cleaning fluid injection system (42) mounted in the cleaning device to inject cleaning fluid (42) inside the filter cartridge when the filter cartridge is connected to the rotating bearing of the housing. The housing of the cleaning device may comprise a perforated tube (49) having perforations in its wall, and the perforated tube is connected to the cleaning fluid injection system such that the cleaning fluid is injected inside the perforated tube and exits the perforated tube through the perforations before arriving inside the filter cartridge.

The actuation means may comprise a variable speed controller functionally to vary the rotation speed of the filter cartridge.

The present invention also relates to an improved method for cleaning a used filter cartridge, the method comprising:
positioning the filter cartridge inside a cleaning device as described above,
rotating the filter cartridge at a sufficiently high speed to substantially remove the residues captured inside the filter cartridge through the centrifugal effect caused by the rotation.

The cleaning of the used cartridge may also be assisted by injecting a liquid during the rotation of the cartridge.

What is claimed is:

1. A reusable filter cartridge comprising:
a tubular outer pipe having perforations arranged therein;
a tubular inner pipe having perforations arranged therein and having a diameter smaller than the diameter of the outer pipe such that an annulus is formed between the outer and inner pipes;
a filtering media disposed in the annulus between the outer and inner pipes; and
a first and a second lid, each being secured at opposite ends of the outer and inner pipes, one of the lids having a central opening therein for water to flow out of or into the inner pipe; and
wherein the reusable filter cartridge further comprises a coupling arrangement such that the filter cartridge can be coupled to a cleaning device so that the filtering media can be cleaned by rotation of the filter cartridge around its axis inside the cleaning device.

2. The reusable filter cartridge as claimed in claim 1, wherein the coupling arrangement comprises an extending sleeve member securely attached to or integrally formed with the lid having a central opening therein and which can couple with a rotating element of the cleaning device so that the filter cartridge can rotate about its axis.

3. The reusable filter cartridge as claimed in claim 1, which is a radial flow water filter cartridge.

4. The reusable filter cartridge as claimed in claim 1, wherein the filtering media is a polymer material.

5. The reusable filter cartridge as claimed in claim 4, wherein the filtering media is a polyurethane-based material.

6. The reusable filter cartridge as claimed in any of claim 1, which has a symmetrical structure.

7. A cleaning device for cleaning a used reusable filter cartridge as claimed in claim 1, which includes residues, the cleaning device comprising:
a housing; and
wherein at least one coupling arrangement to which the reusable filter cartridge is attachable is located in the housing; and
an actuating means being operably attached to the coupling arrangement for rotating the coupling arrangement in order to substantially remove the residues at least partially through centrifugation.

8. The cleaning device as claimed in claim 7, further comprising a cleaning fluid injection system which enables cleaning fluid to be injectable into the reusable filter cartridge when it is connected to the rotating bearing.

9. The cleaning device according to claim 7, wherein the actuating means comprises a variable speed controller to vary the speed at which the reusable filter cartridge is rotated.

10. The cleaning device as claimed in claim 7, wherein the housing comprises a protection shield that is mounted to surround the reusable filter cartridge and receive residues which are able to exit the filter cartridge due to centrifugal forces during the cleaning process.

11. The cleaning device as claimed in claim 10, which further comprises a recovery vessel which is mounted relative to the protection shield to receive the residues from the protection shield.

12. The cleaning device as claimed in claim 7, wherein the residues include oil.

13. A method of cleaning a reusable filter cartridge as claimed in claim 1 using a cleaning device as claimed in claim 7, the method comprising:
coupling the reusable filter cartridge to the cleaning device; and
rotating the reusable filter cartridge at a sufficiently high speed to substantially remove the residues captured inside the filter cartridge through the centrifugal effect caused by the rotation.

14. The method of cleaning as claimed in claim 13, which further comprises injecting a liquid such as a cleaning fluid into the reusable filter cartridge to assist the cleaning process.

15. The method of cleaning as claimed in claim 13, wherein the speed of rotation of the reusable filter cartridge can be varied.
